(19) United States
(12) Patent Application Publication
(10) Pub. No.: US 2013/0252816 A1
(43) Pub. Date: Sep. 26, 2013

(54) HERBICIDAL COMPOSITION AND USE THEREOF

(71) Applicants: Randall Charles Cush, Basel (CH); Georg Rudiger Kotzian, Basel (CH); Christian Popp, Muenchwilen (CH); Krystyna Opalski, Sela (MY)

(72) Inventors: Randall Charles Cush, Basel (CH); Georg Rudiger Kotzian, Basel (CH); Christian Popp, Muenchwilen (CH); Krystyna Opalski, Sela (MY)

(73) Assignee: Syngenta Crop Protection LLC, Greensboro, NC (US)

(21) Appl. No.: 13/821,183

(22) PCT Filed: Sep. 9, 2011
(86) PCT No.: PCT/EP2011/065605

§ 371 Date: Jun. 6, 2013

(30) Foreign Application Priority Data
Sep. 10, 2010 (GB) 1015167.8

(51) Int. Cl. A01N 25/00; A01N 57/20

(52) U.S. Cl. CPC A01N 25/00; A01N 57/20
USPC 504/206

(57) ABSTRACT

The present invention relates to the use of a branched-chain alcohol ethoxylate adjuvant as a rapid visual indicator of a locus of herbicidal treatment. In particular the invention includes novel herbicidal compositions comprising glyphosate and such an adjuvant, as well as the use of such compositions in combating unwanted plant growth. Compositions of the invention not only exhibit rapid symptomology, but also provide long-lasting control of unwanted plant growth across a broad spectrum of plants.

The present invention relates to the use of a branched-chain alcohol ethoxylate adjuvant as a rapid visual indicator of a locus of herbicidal treatment. In particular the invention includes novel herbicidal compositions comprising glyphosate and such an adjuvant, as well as the use of such compositions in combating unwanted plant growth.

Glyphosate is a well-known established broad-spectrum non-specific herbicide. Routinely formulations comprising glyphosate are applied by spray to the foliar tissue of unwanted plants and although glyphosate provides highly effective control of such unwanted plants, its uptake into the plants is relatively slow. Consequentially, visual symptoms of phytotoxicity or burndown are also delayed and typically do not appear until 7 to 10 days after treatment. In several sectors of the herbicide market, in particular in lawn and garden, this delay in the appearance of phytotoxic symptoms may have several disadvantages in that it may give rise to a misconception that the product is not working, and furthermore it is difficult for the user to assess rapidly whether he has treated all of the area where his unwanted plants are growing.

These disadvantages have been addressed by providing herbicidal compositions of glyphosate and a further herbicide, wherein the further herbicide provides for early visible burndown symptoms yet still allows for sufficient uptake of glyphosate to maintain long term glyphosate-mediated weed control: U.S. Pat. No. 5,532,205 describes a herbicidal composition comprising (i) N-phosphonomethylglycine or an agriculturally acceptable salt thereof in combination with (ii) paraquat or diquat or a mixture thereof and (iii) a herbicide which functions as a photosystem II inhibitor. U.S. Pat. No. 7,008,904 describes herbicidal compositions of glyphosate, a bipyridilium (such as diquat or paraquat) and a surfactant that is of a type and present in a concentration sufficient to allow the plant to uptake a herbicidally effective amount of glyphosate prior to the substantial onset of bipyridilim induced leaf damage that would prevent or severely reduce further uptake of glyphosate by the plant. US2006/0063678 describes aqueous herbicidal glyphosate compositions comprising glyphosate, pelargonic acid and a nonionic surfactant component comprising certain water-soluble alkoxylated alcohols.

The present invention is based on the unexpected finding that certain branched chain alcohol ethoxylate adjuvants, when applied in combination with glyphosate are capable of acting as rapid visual indicators of glyphosate treatment. The compositions of the present invention not only provide rapid symptoms of phytoxicity whilst preserving prolonged control in plants treated with said compositions, but also have an enhanced safety and toxicity profile in comparison to compositions of the prior art comprising bipyridilium herbicides. Furthermore, since the rapid symptomology is not effected by a second herbicide, formulations of the present invention are simplified.

Thus according to a first aspect the invention provides the invention provides a composition comprising glyphosate and a branched chain alcohol ethoxylate molecule of general formula (I), R¹—O(CH₂CH₂O)_{y}—H (I),

wherein y is an integer between 2 and 15 inclusive, and R¹ is a branched C₈-C₁₈ alkyl chain, and wherein said composition comprises the branched chain alcohol ethoxylate at a concentration greater than 1% w/v, provided said branched chain alcohol ethoxylate is not 2,4,6,8,-tetramethylnonyl alcohol ethoxylate with 7 moles of ethoxylation.

Further aspects of the invention include compositions of the invention in ready-to-use form, as well as in concentrate form.

A further aspect of the invention relates to the use of a branched chain alcohol ethoxylate, in admixture with glyphosate, as a visual indicator of the locus of glyphosate treatment.

A still further aspect relates to the use of compositions of the invention to control unwanted plant growth.

Branched chain alcohol ethoxylate molecules for use in the invention will be of general formula R¹—O(CH₂CH₂O)_{y}—H, wherein y is an integer between 2 and 15 inclusive, and R¹ is a branched C₈-C₁₈ alkyl chain, with the exclusion of 2,4,6,8,-tetramethylnonyl alcohol ethoxylate with 7 moles of ethoxylation.

In preferred embodiments R¹ is a C₁₀-C₁₆ alkyl chain, preferably a C₁₂-C₁₆ alkyl chain, more preferably a C₁₂-C₁₄ alkyl chain, and most preferably a C₁₃ alkyl chain.

As stated above, branched chain alcohol ethoxylates for use in the invention may be ethoxylated to different extents: they will contain between 2 and 15 moles of ethoxylation (i.e. y in formula (I) denotes the number of moles of ethoxylation, and is between 2 and 15 inclusive). In preferred embodiments y is an integer between 5 and 15 inclusive, more preferably between 5 and 8 inclusive, and most preferably 6 or 8.

Examples of particularly useful branched chain alcohol ethoxylates for use in the invention include iso-tridecyl alcohol polyglycol ethoxylates with 2, 5, 6, 8, or 15 moles of ethoxylation. These are commercially available from Clariant under the trade names of Genapol™ X 020, Genapol™ X 050, Genapol™ X 060, Genapol™ X 080 and Genapol™ X 150 respectively.

Branched chain alcohol ethoxylates as described above, may be employed in any aspect of the invention as appropriate at any suitable concentration above 1% w/v, up to about 40% w/v. Preferred concentrations are 1.25%, 1.5%, 1.75%, 2.0%, 2.5%, 2.75%, 3%, 5%, 10%, 15%, 20%, 25%, 30% or 40% w/v.

Compositions of the invention may be in the form of a ready-to-use (RTU) composition, which is suitable for direct application without requiring further dilution. Typically such compositions will comprise more than 1% and less than or equal to 5% w/v, preferably more than 1% but less than or equal to 3% w/v, more preferably between approximately 1.75% and 2.5% w/v inclusive. In particular embodiments such ready-to-use compositions comprise approximately 1.25%, 1.5%, 1.75%, 2.0%, 2.5%, 2.75%, 3%, or 5% w/v branched chain alcohol ethoxylate.

Compositions of the invention may also be in the form of a concentrate, which when diluted for use comprises more than 1% but less than or equal to 5% w/v branched chain alcohol ethoxylate. Concentrate compositions of the invention will preferably comprise at least 5%, and may contain 10%, 15%, 20%, 25%, 30% or 40% w/v. Preferably diluted concentrate compositions (i.e. compositions in use) will comprise more than 1% but less than equal to 3% w/v branched chain alcohol ethoxylate.

Compositions of the invention not only comprise a branched chain alcohol ethoxylate as described hereinbefore, but also glyphosate. The term glyphosate as used herein includes N-(phosphonomethyl)glycine, as well agronomically acceptable salts, adducts, or esters thereof. In particular the term glyphosate encompasses the potassium, monoammonium, diammonium, sodium, monoethanolammonium, n-propylammonium, iso-propylammonium, ethylammonium, dimethylammonium, ethylenediamine, butylamine, monoisopropylamine, hexamethylenediamine and trimethylsulfonium salts of N-(phosphonomethyl)glycine.

Compositions of the invention, in particular ready-to-use compositions, are of particular use in the lawn & garden market. Typically ready-to-use compositions will comprise between about 0.7% and 1.0% w/v glyphosate, depending upon the salt of glyphosate employed, and in particular may comprise 0.72% w/v acid equivalent (a.e.), 0.83% w/v (a.e), or 0.97% w/v isopropylamine salt of glyphosate. With respect to concentrates, these typically contain between about 15% to 50% w/v glyphosate, and in particular may contain 15.3% w/v a.e. 36% w/v a.e. or 50% w/v a.e. glyphosate.

Although of particular use in the lawn & garden arena, compositions of the invention may be used as non-selective herbicides for the control of unwanted plants in the crop production arena. Where compositions of the invention are employed on such a large scale the glyphosate application rate, in terms of glyphosate acid equivalent (a.e.) may vary depending on, for example species, age, stress, time of year, crop rotation, biotype etc., but common rates include 560 g. a.e./ha, 1120 g a.e./ha, and 1680 g a.e./ha.

Branched chain alcohol ethoxylates as described herein are capable of conferring rapid symptomology to herbicidal compositions comprising glyphosate. The phrase “rapid symptomology” as used herein means the ability to produce visual symptoms of phytotoxicity (for example wilting, browning, desiccation, bleaching, necrosis, or any other visual symptom of injury) on treated plants, in a time period after treatment within which glyphosate per se is typically incapable of producing such symptoms. As stated supra glyphosate does not typically produce any visual symptoms of phytotoxicity until 7-10 days after treatment. Accordingly, symptoms appearing within 5 days of treatment, preferably within 48 hours of treatment, more preferably within 24 hours of treatment and most preferably within 12 hours of treatment, are considered as appearing “rapidly”.

Thus in a further aspect of the invention there is provided a method of indicating the locus of glyphosate treatment, said method comprising applying a branched chain alcohol ethoxylate in admixture with glyphosate to unwanted plants at a locus at which the unwanted plants are growing, and visually assessing said locus within a time period of less than 5 days after treatment, wherein the presence of plants exhibiting visual symptoms of phytotoxicity is indicative that said locus has been treated with a composition comprising glyphosate.

Branched chain alcohol ethoxylates, and the concentration thereof and of glyphosate that is admixed in the above method are preferably as described supra in respect of compositions of the invention. In preferred embodiments visual assessment of the locus at which unwanted plants are growing will be carried out within a time period of 48 hours or less from treatment, preferably 24 hours or less from treatment, and most preferably 12 hours of less from treatment.

As mentioned hereinbefore, compositions of the invention are of use in controlling unwanted plant growth. Thus in a further aspect there is provided a method of controlling unwanted plant growth, which comprises applying to said unwanted plants a composition as described hereinbefore. An unwanted plant is any plant growing at a locus where the user of the composition does not wish it to grow. Thus unwanted plants include monocot and dicot weeds (i.e. grasses, sedges, and broadleaf weeds), as well as crop plants growing as volunteers or escapes. Compositions of the invention are particularly useful in controlling (and exhibiting rapid symptomology in) a broad spectrum of unwanted plants, including for example, Abutilon threophrasti, Amaranthus spp., Artemisia spp., Asclepias spp., Borreria spp., Brassica spp., Cirsium arvense, Commelina spp., Convolvuslus arvensis, Erodium spp., Helianthus spp., Ipomea spp., Kochia scoparia, Malva spp., Polygonum spp., Pteridium aquilinum, Pueraria spp., Rubus spp., Salsola spp., Sida spp., Sinapis arvensis, Stellaria spp. (in particular Stellaria media), Taraxacum officinale, Trifolium repens, Ulex europaeus, Urtica dioica, Veronica persica, Xanthium spp., Agropyron repens, Avena fatua, Axonopus spp., Brachiara spp., Bromus tectorum, Cynodon dactylon, Digitaria spp., Echinochloa spp., Eleusine indica, Elymus repens, Equisetum spp., Imperata cylindrica, Lolium multiflorum, Lolium perenne, Oryza sativa, Ottochloa nodosa, Panicum maximum, Paspalum dilatatum, Paspalum notatum, Phalaris spp., Phragamites spp., Poa annua, Setaria spp., Sorghum halepense, Triticum aestivum, Typha spp., and Zea mays.

The term “plant” refers to all physical parts of a plant, including seeds, seedlings, saplings, roots, tubers, stems, stalks, foliage and fruits.

In order to act as an indicator of the locus of glyphosate treatment, a branched chain alcohol ethoxylate, preferably as described hereinbefore, will be applied in admixture with glyphosate to said unwanted plants through any appropriate method known to the skilled man. Similarly, in order to control unwanted plant growth, compositions of the invention will be applied to said unwanted plants through any appropriate method known to the skilled man. Typically application to unwanted plants will be by spray to foliar tissue.

In one particular embodiment a ready-to-use composition of the invention is packaged in a portable container suitable for hand carry (or suitable for carrying on the back), said container being fitted with apparatus for releasing said composition from the container onto the foliage of the unwanted plants in the form of a spray.

In a further embodiment glyphosate and the branched chain alcohol ethoxylate will be packaged separately (for example as a combi-pack), and the packages may be arranged such that the branched chain alcohol ethoxylate and glyphosate can be admixed immediately prior to application.

Compositions of the invention may be formulated in any suitable manner known to the man skilled in the art. For example, branched chain alcohol ethoxylates may readily be combined with or included within known glyphosate formulations. Typically such formulations will also comprise ammonium sulphate.

Compositions and/or formulations of the invention may comprise an additional herbicidal agent and/or an additional rapid symptomology component. However, it is preferred that the branched chain alcohol ethoxylate will be the main (particularly preferably, the sole) component conferring rapid symptomology upon compositions of the invention, and it is further preferred that glyphosate will be the major herbicidal component to confer prolonged weed control effects on compositions of the invention. In the most preferred embodiments rapid symptomology will be conferred solely by the branched chain alcohol ethoxylate and prolonged weed control will be conferred solely by glyphosate.

It should also be appreciated that the invention extends to compositions of the invention comprising more than one branched chain alcohol ethoxylate. In such compositions the combined concentration of branched chain alcohol ethoxylate will be greater than 1% w/v, and preferably the combined concentration will be as stated supra in respect of an individual branched chain alcohol ethoxylate. More preferably each branched chain alcohol ethoxylate will be at a concentration greater than 1% w/v, or as stated above.

The skilled man will appreciate that the preferences described above with respect to various aspects and embodiments of the invention may be combined in whatever way is deemed appropriate.

Various aspects and embodiments of the present invention will now be illustrated in more detail by way of example. It will be appreciated that modification of detail may be made without departing from the scope of the invention.

### EXAMPLES

### Example 1

### Effect of Different Adjuvants on Weed Species: Comparison of Different Types of Adjuvant

The effect of different adjuvants (see Table 1 below) on the growth of broadleaf weed and grass species was investigated and compared to untreated (water only) control weeds.

TABLE 1
Adjuvants tested

| Trade name | Source | Description |
|---|---|---|
| Genapol ™ O050 | Clariant | Oleyl alcohol polyglycol ether with |
| | | 5 moles of ethoxylation |
| Genapol ™ O100 | Clariant | Oleyl alcohol polyglycol ether with |
| | | 10 moles of ethoxylation |
| Genapol ™ O150 | Clariant | Oleyl alcohol polyglycol ether with |
| | | 15 moles of ethoxylation |
| Genapol ™ O200 | Clariant | Oleyl alcohol polyglycol ether with |
| | | 20 moles of ethoxylation |
| Genapol ™ X060 | Clariant | Iso-tridecyl alcohol polyglycol ether |
| | | with 6 moles of ethoxylation |
| Genapol ™ X150 | Clariant | Iso-tridecyl alcohol polyglycol ether |
| | | with 15 Moles of ethoxylation |
| AGNIQUE | Cognis | C₈-C₁₀ alkyl polyglucoside |
| PG8107-G/-U | | |
| EMULSOGEN ™ | Clariant | Castor oil ethoxylate with 36 Moles |
| EL 360 | | of ethoxylation |
| SAPOGENAT ™ | Clariant | Tri-sec-butylphenol polyglycol ether |
| T 060 | | with 6 Moles of ethoxylation |
| Merge ™ | BASF | Surfactant blend with petroleum |
| | | hydrocarbons |
| GENOL PLANT/ | Maag | Rapeseed oil based additive |
| Sanoplant | | |
| (Sanoplant | | |
| winteröl) | | |

Plates, each with 48 pots measuring 2.7 cm diameter and 5 cm deep, were filled with TKS1 growing media (Floragard, Germany). Seeds of Taraxacum officinale, Stellaria media or Poa annua were sown on the surface (10 to 20 per pot). Plants were grown in glasshouse at a temperature of 18 to 20° C. and at 60% relative humidity.

Plants were treated 15 (Stellaria, Poa) and 34 (Taraxacum) days after sowing with 60 μl of a 1.25, 2.5, 5 and 10% (w/v) solution of adjuvant using a hand airbrush.

Visual assessment of the percentage damage to the plant was carried out 1 day and 6 days from application.

Damage was assessed as wilting, desiccation or any other kind of visual injury in comparison to the untreated control (water only). The results are shown in Table 2 below.

TABLE 2
Average % damage caused to broadleaf weed and grass species at 1 and 6 days
after treatment with various adjuvants in comparison to untreated (water only) control

| | | avg % damage 1 DAA | | | avg % damage 6 DAA | | |
|---|---|---|---|---|---|---|---|
| | Concentration | Taraxacum | | | Taraxacum | | |
| Adjuvant | % w/v | officinale | Stellaria media | Poa annua | officinale | Stellaria media | Poa annua |
| GenapolO050 | 10 | 10 | 30 | 0 | 0 | 25 | 10 |
| GenapolO050 | 5 | 10 | 15 | 0 | 20 | 25 | 10 |
| GenapolO050 | 2.5 | 10 | 10 | 0 | 3 | 15 | 5 |
| GenapolO050 | 1.25 | 10 | 0 | 0 | 0 | 0 | 5 |
| GenapolO100 | 10 | 5 | 50 | 0 | 0 | 55 | 10 |
| GenapolO100 | 5 | 5 | 15 | 0 | 0 | 30 | 10 |
| GenapolO100 | 2.5 | 5 | 5 | 0 | 0 | 10 | 10 |
| GenapolO100 | 1.25 | 0 | 0 | 0 | 0 | 5 | 5 |
| GenapolO150 | 10 | 5 | 43 | 0 | 3 | 60 | 0 |
| GenapolO150 | 5 | 5 | 13 | 0 | 3 | 30 | 0 |
| GenapolO150 | 2.5 | 0 | 0 | 0 | 0 | 20 | 0 |
| GenapolO150 | 1.25 | 0 | 0 | 0 | 3 | 5 | 0 |
| GenapolO200 | 10 | 10 | 15 | 0 | 0 | 30 | 0 |
| GenapolO200 | 5 | 0 | 0 | 0 | 5 | 5 | 0 |
| GenapolO200 | 2.5 | 0 | 0 | 0 | 0 | 5 | 0 |
| GenapolO200 | 1.25 | 0 | 0 | 0 | 3 | 0 | 0 |
| GenapolX060 | 10 | 45 | 60 | 70 | 35 | 85 | 80 |
| GenapolX060 | 5 | 30 | 35 | 75 | 40 | 65 | 80 |
| GenapolX060 | 2.5 | 10 | 30 | 55 | 20 | 40 | 70 |
| GenapolX060 | 1.25 | 5 | 25 | 45 | 20 | 35 | 50 |
| GenapolX-150 | 10 | 10 | 25 | 0 | 0 | 25 | 10 |
| GenapolX-150 | 5 | 20 | 15 | 0 | 10 | 15 | 10 |
| GenapolX-150 | 2.5 | 10 | 0 | 0 | 0 | 10 | 5 |
| GenapolX-150 | 1.25 | 10 | 0 | 0 | 5 | 10 | 10 |
| AGNIQUE PG 8107-G/-U | 10 | 3 | 5 | 0 | 13 | 10 | 15 |
| AGNIQUE PG 8107-G/-U | 5 | 0 | 5 | 0 | 10 | 10 | 5 |
| AGNIQUE PG 8107-G/-U | 2.5 | 0 | 0 | 0 | 0 | 0 | 10 |
| AGNIQUE PG 8107-G/-U | 1.25 | 0 | 0 | 0 | 5 | 0 | 5 |
| EMULSOGEN EL 360 | 10 | 0 | 5 | 0 | 0 | 15 | 0 |
| EMULSOGEN EL 360 | 5 | 0 | 5 | 0 | 0 | 0 | 0 |
| EMULSOGEN EL 360 | 2.5 | 0 | 0 | 0 | 0 | 0 | 0 |
| EMULSOGEN EL 360 | 1.25 | 0 | 0 | 0 | 0 | 0 | 0 |
| SAPOGENAT T 060 | 10 | 0 | 0 | 0 | 0 | 20 | 35 |
| SAPOGENAT T 060 | 5 | 0 | 0 | 0 | 0 | 20 | 25 |
| SAPOGENAT T 060 | 2.5 | 0 | 0 | 0 | 0 | 0 | 5 |
| SAPOGENAT T 060 | 1.25 | 0 | 0 | 0 | 0 | 0 | 5 |
| Merge | 10 | 10 | 0 | 0 | 13 | 15 | 10 |
| Merge | 5 | 10 | 0 | 0 | 5 | 5 | 5 |
| Merge | 2.5 | 3 | 0 | 0 | 3 | 0 | 5 |
| Merge | 1.25 | 3 | 0 | 0 | 3 | 0 | 5 |
| GENOL PLANT/Sanoplant | 10 | 0 | 5 | 0 | 0 | 10 | 0 |
| GENOL PLANT/Sanoplant | 5 | 0 | 5 | 0 | 0 | 10 | 0 |
| GENOL PLANT/Sanoplant | 2.5 | 0 | 0 | 0 | 0 | 10 | 0 |
| GENOL PLANT/Sanoplant | 1.25 | 0 | 0 | 0 | 0 | 0 | 0 |
| Control | | 0 | 0 | 0 | 0 | 0 | 0 |

Surprisingly branched chain alcohol ethoxylate adjuvants (Genapol™ X060 and Genapol™ X150) gave a comparatively high level of visual symptoms of phytoxicity in both broadleaf weeds and grasses at 1 and 6 days after treatment, in comparison to linear alcohol ethoxylate and other classes of adjuvant, which gave little or no visual symptoms of phytotoxicity.

### Example 2

### Effect of Different Alcohol Ethoxylate Adjuvants on Weed Species

The effect of different types of alcohol ethoxylate (branched—Genapol X-series, and unbranched—Genapol O-series, differing degrees of ethoxylation, see Table 3 below for more details), on unwanted vegetation (broadleaf weed and grass species), in the absence of glyphosate, was investigated and compared to untreated (water only) control weeds.

TABLE 3
Alcohol ethoxylate adjuvants tested

| Trade name | Source | Description |
|---|---|---|
| Genapol ™ O020 | Clariant | Oleyl alcohol polyglycol ether with |
| | | 2 moles of ethoxylation |
| Genapol ™ O050 | Clariant | Oleyl alcohol polyglycol ether with |
| | | 5 moles of ethoxylation |
| Genapol ™ O080 | Clariant | Oleyl alcohol polyglycol ether with |
| | | 8 moles of ethoxylation |
| Genapol ™ X020 | Clariant | Iso-tridecyl alcohol polyglycol ether |
| | | with 2 moles of ethoxylation |
| Genapol ™ X060 | Clariant | Iso-tridecyl alcohol polyglycol ether |
| | | with 6 moles of ethoxylation |
| Genapol ™ X080 | Clariant | Iso-tridecyl alcohol polyglycol ether |
| | | with 8 moles of ethoxylation |

Troughs (measuring 16 cm by 13 cm by 5 cm) were filled with local field soil. Seeds of Veronica persica, Stellaria media, Trifolium repens and Poa annua were sown 24 days before application of test samples. Plants were grown in the glasshouse at 18 to 20° C. and 60% relative humidity. Application of alcohol ethoxylate test samples was carried out using a tracksprayer, spraying at a rate of 300 l/ha. Plants were kept in glasshouse and visual assessment of the estimated percentage damage to the plant was carried out 1, 7, and 14 days from application.

Damage was assessed as wilting, desiccation or any other kind of visual injury in comparison to the untreated control (water only). The results are summarized in Table 4 below.

The data shows that in the linear (unbranched) alcohol ethoxylate adjuvants (Genapol™ O series) had little or no effect on the weed species tested at any of the time points analysed.

TABLE 4
Average % damage caused to broadleaf weed and grass species at 1, 7 and 14 days
after treatment with various adjuvants in comparison to untreated (water only) control

| | | | | | | mean % | |
|---|---|---|---|---|---|---|---|
| | | mean % damage 1 daa | | | | damage 7 daa | |
| Adjuvant/ | Concentration | Trifolium | Stellaria | Veronica | Poa | Trifolium | Stellaria |
| Treatment | (% w/v) % | repens | media | persica | annua | repens | media |
| GenapolO020 | 1 | 0 | 0 | 0 | 0 | 0 | 0 |
| | 1.5 | 0 | 0 | 0 | 0 | 0 | 0 |
| | 2 | 0 | 0 | 0 | 0 | 0 | 0 |
| | 2.5 | 0 | 0 | 0 | 0 | 10 | 5 |
| GenapolO050 | 1 | 0 | 0 | 0 | 0 | 5 | 5 |
| | 1.5 | 0 | 0 | 0 | 0 | 5 | 5 |
| | 2 | 0 | 0 | 0 | 0 | 5 | 10 |
| | 2.5 | 0 | 0 | 0 | 0 | 5 | 10 |
| GenapolO080 | 1 | 0 | 0 | 0 | 0 | 0 | 0 |
| | 1.5 | 0 | 0 | 0 | 0 | 0 | 0 |
| | 2 | 5 | 0 | 0 | 0 | 0 | 5 |
| | 2.5 | 5 | 0 | 0 | 0 | 10 | 0 |
| GenapolX020 | 1 | 0 | 0 | 0 | 0 | 0 | 0 |
| | 1.5 | 5 | 0 | 0 | 0 | 5 | 0 |
| | 2 | 10 | 0 | 5 | 0 | 5 | 5 |
| | 2.5 | 10 | 0 | 5 | 0 | 5 | 5 |
| GenapolX060 | 1 | 40 | 5 | 10 | 20 | 40 | 5 |
| | 1.5 | 60 | 10 | 20 | 20 | 50 | 10 |
| | 2 | 70 | 10 | 70 | 40 | 60 | 30 |
| | 2.5 | 70 | 20 | 60 | 40 | 60 | 40 |
| GenapolX080 | 1 | 20 | 10 | 5 | 0 | 20 | 10 |
| | 1.5 | 50 | 10 | 10 | 10 | 60 | 10 |
| | 2 | 50 | 20 | 20 | 40 | 60 | 20 |
| | 2.5 | 50 | 30 | 30 | 40 | 60 | 30 |

| | | mean % | | | | | |
|---|---|---|---|---|---|---|---|
| | | damage 7 daa | | mean % damage 14 daa | | | |
| Adjuvant/ | Concentration | Veronica | Poa | Trifolium | Stellaria | Veronica | Poa |
| Treatment | (% w/v) % | persica | annua | repens | media | persica | annua |
| GenapolO020 | 1 | 0 | 0 | 0 | 0 | 0 | 0 |
| | 1.5 | 0 | 0 | 0 | 0 | 0 | 0 |
| | 2 | 0 | 0 | 0 | 0 | 0 | 0 |
| | 2.5 | 0 | 0 | 0 | 0 | 0 | 0 |
| GenapolO050 | 1 | 5 | 10 | 0 | 0 | 5 | 0 |
| | 1.5 | 10 | 5 | 0 | 5 | 20 | 0 |
| | 2 | 10 | 5 | 0 | 5 | 20 | 5 |
| | 2.5 | 20 | 5 | 0 | 10 | 20 | 5 |
| GenapolO080 | 1 | 5 | 5 | 0 | 0 | 10 | 0 |
| | 1.5 | 0 | 5 | 0 | 5 | 10 | 0 |
| | 2 | 0 | 5 | 0 | 0 | 0 | 0 |
| | 2.5 | 5 | 5 | 10 | 10 | 0 | 0 |
| GenapolX020 | 1 | 0 | 0 | 0 | 0 | 0 | 0 |
| | 1.5 | 0 | 5 | 0 | 0 | 0 | 0 |
| | 2 | 5 | 5 | 0 | 5 | 5 | 0 |
| | 2.5 | 5 | 5 | 10 | 0 | 5 | 0 |
| GenapolX060 | 1 | 10 | 30 | 0 | 0 | 5 | 10 |
| | 1.5 | 20 | 40 | 0 | 0 | 10 | 10 |
| | 2 | 70 | 50 | 0 | 10 | 50 | 15 |
| | 2.5 | 40 | 50 | 5 | 20 | 40 | 0 |
| GenapolX080 | 1 | 5 | 10 | 15 | 5 | 5 | 0 |
| | 1.5 | 20 | 30 | 10 | 0 | 20 | 5 |
| | 2 | 10 | 50 | 15 | 10 | 20 | 10 |
| | 2.5 | 40 | 50 | 10 | 10 | 40 | 20 |

In comparison, (in particular for a given degree of ethoxylation) the branched chain alcohol ethoxylate adjuvants in general demonstrated a greater degree of phytoxicity at each time point.

The data also shows that whilst plants treated with Genapol™ X060 and Genapol™ X080 (in the absence of glyphosate) exhibit symptoms of a phytotoxicity at all time points, the level of damage decreases from day 14 onwards, as the plants begin to recover.

### Example 3

### Effect on Weeds of Branched Chain Alcohol Ethoxylate Adjuvants in Admixture with Glyphosate

The effects of different branched chain alcohol ethoxylates in admixture with glyphosate on both Dandelions and a mixture of grasses were investigated.

Dandelion samples and a mixture of grasses obtained from a meadow environment were planted into square 20 cm pots and kept and grown on in glasshouse for at least 2 weeks (18 to 20° C., 60% relative humidity).

Application of branched chain alcohol ethoxylate was carried out using a tracksprayer, spraying at a rate of 600 l/ha.

Visual assessment of the estimated percentage damage to the plant was carried out 1, 6, 13, and 20 days from application.

Damage was assessed as wilting, desiccation or any other kind of visual injury in comparison to the untreated control (water only). The results are summarised in Table 5 below.

The data shows that the branched chain alcohol ethoxylate adjuvants tested are as effective at providing rapid symptomology as the commercially available “fast-acting” glyphosate compositions wherein rapid symptomology is brought about via a second herbicide (i.e. diquat or pelargonic acid).

The data also shows that whilst plants treated with Genapol X060 in the absence of glyphosate exhibit symptoms of a phytotoxicity at all time points, the level of damage decreases from day 13 onwards, as the plants begin to recover.

TABLE 5
Effect of different branched chain alcohol ethoxylates in admixture with glyphosate on both Dandelions and a mixture of grasses

| | | | % Damage | | % Damage | | % Damage | | % Damage | |
|---|---|---|---|---|---|---|---|---|---|---|
| | Herbicidal active | Adjuvant | 1 daa | | 6 daa | | 13 daa | | 20 daa | |
| Treatment | ingredient [w/v] | [w/v] | Dandelion | Grass mix | Dandelion | Grass mix | Dandelion | Grass mix | Dandelion | Grass mix |
| Resolva | Glyphosate [0.83%] | — | 40 | 20 | 70 | 70 | 90 | 90 | 90 | 90 |
| | Diquat [0.03%] | — | | | | | | | | |
| RoundUp Fast | Glyphosate [0.72%] | — | 20 | 0 | 20 | 30 | 90 | 50 | 90 | 70 |
| Action | Pelargonic acid [2%] | — | | | | | | | | |
| Weedbuster + | Glyphosate | Genapol | 40 | 10 | 70 | 30 | 90 | 70 | 90 | 70 |
| GenapolX020 | | X020 [5%] | | | | | | | | |
| Weedbuster + | Glyphosate | Genapol | 40 | 20 | 70 | 60 | 98 | 98 | 98 | 100 |
| GenapolX060 | | X060 [5%] | | | | | | | | |
| Weedbuster + | Glyphosate | Genapol | 30 | 10 | 50 | 30 | 98 | 80 | 100 | 80 |
| GenapolX150 | | X150 [5%] | | | | | | | | |
| GenapolX060 | — | Genapol | 40 | 20 | 50 | 50 | 30 | 40 | 20 | 40 |
| | | X060 [5%] | | | | | | | | |
| Control | — | — | 0 | 0 | 0 | 0 | 0 | 0 | 0 | 0 |

### Example 4

### Effect on Weeds of Different Concentrations of Branched Chain Alcohol Ethoxylate in Presence and Absence of Glyphosate

The effect on broadleaf weeds and grasses of different concentrations of Genapol™ X060 (iso-tridecyl alcohol polyglycol ether with 6 moles of ethoxylation) in admixture with glyphosate was investigated.

Troughs (measuring 55 cm by 9 cm by 8.5 cm) were filled with local field soil. Seeds of Taraxacum officinale, Urtica dioica, Trifolium repens and Poa annua were sown 41 days before application of test samples, and seeds of Stellaria media, Veronica persica, Agropyron repens and Lolium multiflorum were sown 24 days before application of test samples. Plants were grown in the glasshouse at 18 to 20° C. and 60% relative humidity. One week before application of test samples, troughs were placed outside (but covered).

Application of test samples was carried out using a tracksprayer, spraying at a rate of 300 l/ha. Treated plants were kept outside and visual assessment of the percentage damage to the plants was carried out at 1, 7, 14, and 21 days after application.

Damage was assessed as wilting, desiccation or any other kind of visual injury in comparison to the untreated control (water only). The results are summarised in Table 6 below.

The results show that admixture of Genapol™X060 at a concentration of 2.5% w/v with glyphosate (in the form of Weedbuster) provided for more rapid symptomology against all weeds in comparison to Roundup, and for more rapid symptomology against most weeds in comparison to Weedbuster. Even at its lowest concentration, Genapol™X060 conferred more rapid symptomology than either Roundup or Weedbuster against some weeds. Furthermore, particularly at higher concentrations, the effect of Genapol™X060 in combination with glyphosate is comparable to the effect of Roundup Fast Action and Resolva.

TABLE 6

| | Herbicidal | | Mean % damage | | | |
|---|---|---|---|---|---|---|
| | Active | [Genapol ™ | at 1, 7, 14, & 21 days after treatment | | | |
| | Ingredient | X060] | Trifolium | Taraxacum | | Stellaria |
| Treatment | [% w/v] | (% w/v) | repens | officianale | Urtica dioica | media |
| Resolva | Glyphosate | — | 60, 90, 98, 98 | 60, 98, 100, 100 | 60, 95, 98, 100 | 20, 90, 98, 98 |
| | Diquat | — | | | | |
| Roundup | Glyphosate | — | 40, 50, 70, 98 | 20, 30, 100, 100 | 30, 40, 98, 100 | 30, 60, 90, 98 |
| Fast Action | Pelargonic acid | — | | | | |
| Weedbuster | Glyphosate | — | 30, 50, 90, 100 | 10, 30, 100, 100 | 20, 40, 90, 98 | 20, 50, 95, 98 |
| Roundup | Glyphosate | — | 0, 30, 90, 100 | 0, 10, 98, 100 | 0, 30, 80, 98 | 0, 50, 95, 100 |
| Weedbuster + | Glyphosate | 1.5 | 20, 40, 80, 98 | 30, 70, 100, 100 | 40, 60, 90, 98 | 10, 30, 95, 100 |
| Genapol ™ | | 1.75 | 20, 60, 90, 98 | 30, 70, 100, 100 | 40, 70, 90, 98 | 10, 80, 98, 100 |
| X060 | | 2 | 20, 30, 70, 90 | 20, 40, 80, 100 | 40, 70, 90, 98 | 10, 80, 98, 98 |
| | | 2.5 | 20, 30, 70, 80 | 40, 40, 80, 100 | 50, 70, 98, 90 | 50, 90, 98, 98 |
| Control | — | — | 0, 0, 0, 0 | 0, 0, 0, 0 | 0, 0, 0, 0 | 0, 0, 0, 0 |

| | Herbicidal | | Mean % damage | | | |
|---|---|---|---|---|---|---|
| | Active | [Genapol ™ | at 1, 7, 14, & 21 days after treatment | | | |
| | Ingredient | X060] | Veronica | Agropyron | | Lolium |
| Treatment | [% w/v] | (% w/v) | persica | repens | Poa annua | multiflorum |
| Resolva | Glyphosate | — | 70, 90, 100, | 30, 98, 100, 100 | 30, 80, 98, 100 | 50, 98, 98, 100 |
| | Diquat | — | 100 | | | |
| Roundup | Glyphosate | — | 30, 30, 98, 100 | 20, 80, 100, 100 | 30, 70, 95, 100 | 30, 60, 98, 100 |
| Fast Action | Pelargonic | — | | | | |
| | acid | | | | | |
| Weedbuster | Glyphosate | — | 30, 50, 95, 100 | 20, 70, 100, 100 | 20, 60, 98, 100 | 30, 80, 98, 100 |
| Roundup | Glyphosate | — | 20, 20, 90, 100 | 10, 50, 100, 100 | 0, 40, 95, 100 | 20, 50, 98, 100 |
| Weedbuster + | Glyphosate | 1.5 | 30, 20, 95, 100 | 30, 60, 100, 100 | 30, 70, 98, 100 | 20, 80, 100, 100 |
| Genapol ™ | | 1.75 | 40, 30, 90, 100 | 20, 70, 100, 100 | 30, 60, 95, 100 | 10, 60, 100, 100 |
| X060 | | 2 | 40, 40, 98, 100 | 20, 80, 100, 100 | 20, 48, 98, 100 | 10, 80, 100, 100 |
| | | 2.5 | 30, 40, 90, 100 | 50, 80, 100, 100 | 40, 80, 98, 100 | 30, 90, 100, 100 |
| Control | — | — | 0, 0, 0, 0 | 0, 0, 0, 0 | 0, 0, 0, 0 | 0, 0, 0, 0 |

1. A composition comprising glyphosate and a branched chain alcohol ethoxylate molecule of general formula (I)
R¹—O(CH₂CH₂O)_{y}—H (I)
wherein y is an integer between 2 and 15 inclusive, and
R¹ is a branched C₈-C₁₈ alkyl chain, and wherein said composition comprises the branched chain alcohol ethoxylate at a concentration greater than 1% w/v, provided said branched chain alcohol ethoxylate is not 2,4,6,8,-tetramethylnonyl alcohol ethoxylate with 7 moles of ethoxylation.

2. A composition according to claim 1 wherein y is an integer between 5 and 8 inclusive.

3. A composition according to claim 1, wherein R¹ is a branched C₁₂-C₁₄ alkyl chain.

4. A composition according to claim 1, in the form of a concentrate, wherein the concentration of the branched chain alcohol ethoxylate is 3% w/v or greater in the concentrate, and greater than 1% w/v and less than or equal to 3% w/v when diluted for use.

5. A composition according to claim 1, in the form of a ready-to-use composition wherein the concentration of the branched chain alcohol ethoxylate is greater than 1% w/v but less than or equal to 5% w/v.

6. Use of a branched chain alcohol ethoxylate in admixture with glyphosate, as a visual indicator of the locus of glyphosate treatment.

7. A method of indicating the locus of glyphosate treatment, said method comprising applying a branched chain alcohol ethoxylate in admixture with glyphosate to unwanted plants at a locus at which the unwanted plants are growing, and visually assessing said locus within a time period of less than 5 days after treatment, wherein the presence of plants exhibiting visual symptoms of phytotoxicity is indicative that said locus has been treated with a composition comprising glyphosate.

8. The method according to claim 7, wherein the admixture of glyphosate and a branched chain alcohol ethoxylate is in the form of a composition
comprising glyphosate and a branched chain alcohol ethoxylate molecule of general formula (I)
R¹—O(CH₂CH₂O)_{y}—H (I)
wherein y is an integer between 2 and 15 inclusive, and
R¹ is a branched C₈-C₁₈ alkyl chain, and wherein said composition comprises the branched chain alcohol ethoxylate at a concentration greater than 1% w/v, provided said branched chain alcohol ethoxylate is not 2,4,6,8,-tetramethylnonyl alcohol ethoxylate with 7 moles of ethoxylation.

9. The method according to claim 7, wherein the locus is visually assessed within 24 hours of treatment.

10. (canceled)

11. A method of controlling unwanted plant growth, which comprises applying to said unwanted plants a composition as defined in claim 1.
